(19) United States
(12) Patent Application Publication
(10) Pub. No.: US 2019/0259073 A1
(43) Pub. Date: Aug. 22, 2019

(54) PLACE POPULARITY ESTIMATION SYSTEM

(71) Applicant: NTT DOCOMO, INC., Chiyoda-ku (JP)

(72) Inventors: Ken ENOKIZONO, Chiyoda-ku (JP); Yusuke FUKAZAWA, Chiyoda-ku (JP); Haruka KIKUCHI, Chiyoda-ku (JP); Keiichi OCHIAI, Chiyoda-ku (JP); Shin ISHIGURO, Chiyoda-ku (JP)

(73) Assignee: NTT DOCOMO, INC., Chiyoda-ku (JP)

(21) Appl. No.: 16/346,387

(22) PCT Filed: Mar. 27, 2018
(86) PCT No.: PCT/JP2018/012457

§ 371 Date: Apr. 30, 2019

(30) Foreign Application Priority Data
Apr. 4, 2017 (JP) 2017-074673

(51) Int. Cl. G06Q 30/02; H04W 4/021

(52) U.S. Cl. CPC G06Q 30/0282; H04W 4/021; G06Q 30/0201

(57) ABSTRACT

A place popularity estimation system for estimating popularity of a facility includes a posted-data acquisition unit configured to acquire posted data posted by a user; a posted-data determination unit configured to determine whether the posted data relates to a facility to be estimated and also indicates that a user who has posted the posted data has visited the facility to be estimated; a counting unit configured to count posted data for the facility to be estimated in accordance with the determination; a number-of-people information acquisition unit configured to acquire number-of-people information indicating the number of people who are located in a mesh including the facility to be estimated; a popularity estimation unit configured to estimate popularity of the facility to be estimated, based on a counted value and the number of people indicated by the number-of-people information; and an output unit configured to output information indicating the estimated popularity.

### TECHNICAL FIELD

The present invention relates to a place popularity estimation system for estimating popularity of a place.

### BACKGROUND ART

As described in Patent Literature 1, it has been conventionally proposed to measure and rank popularity of facilities such as restaurants. In Patent Literature 1, the rank is regarded to be set based on the number of people in a block obtained by sectioning a target area. In addition, when a name of a restaurant is described on a website or a bulletin board system on the Internet, the rank of the location where the restaurant exists is to be updated.

### CITATION LIST

### Patent Literature

Patent Literature 1: Japanese Unexamined Patent Publication No. 2007-156637

### SUMMARY OF INVENTION

### Technical Problem

Consider estimating popularity of a facility by using: data of location information that indicates a location of a user and can be extracted from a base station that covers an area where a mobile communication terminal is located, the global positioning system (GPS), or the like; and data posted by the user, such as a microblog. The popularity desired to be estimated indicates how popular as a facility visited by users, that is, how many users are visiting the facility.

Since the data of location information described above usually includes errors, it is only possible to extract information in a certain range, for example, information on the number of people in mesh units. Therefore, it is difficult to grasp, from the data of location information, which facility is actually visited by users. Therefore, as disclosed in Patent Literature 1, it is conceivable to estimate popularity of a facility by correcting the number of people in mesh units, with use of data posted by users. For example, it is conceivable to count a text describing a name of the facility for each facility among texts, which are posted data, and estimate that a facility with a large number of texts is a popular facility.

However, with the above method, even if a text describes a name of a facility that has not been visited, popularity of the facility becomes high. For example, when a facility appears in news of an accident, an incident, or the like, the number of texts describing the name of the facility may become enormous. In such a case, it is impossible to properly estimate the popularity of the facility.

The present invention has been made in view of the above, and it is an object to provide a place popularity estimation system capable of appropriately estimating popularity of a place such as a facility, in consideration of user's visiting.

### Solution to Problem

In order to achieve the above object, a place popularity estimation system according to one embodiment of the present invention is a place popularity estimation system for estimating popularity of a place, and includes: a posted-data acquisition unit configured to acquire posted data posted by a user; a posted-data determination unit configured to determine whether posted data acquired by the posted-data acquisition unit relates to a place to be estimated and also indicates that a user who has posted the posted data has visited the place to be estimated; a counting unit configured to count posted data for the place to be estimated in accordance with determination by the posted-data determination unit; a number-of-people information acquisition unit configured to acquire number-of-people information indicating the number of people who are located in an area including the place to be estimated; a popularity estimation unit configured to estimate popularity of the place to be estimated, based on a value counted by the counting unit and the number of people indicated by the number-of-people information acquired by the number-of-people information acquisition unit; and an output unit configured to output information indicating popularity estimated by the popularity estimation unit.

In the place popularity estimation system according to one embodiment of the present invention, determination is made as to whether posted data relates to a place to be estimated and indicates that a user who has posted the posted data has visited the place to be estimated. Posted data is counted in accordance with the determination, and popularity of the place to be estimated is estimated based on the counted value and the number-of-people information. Therefore, the posted data is appropriately taken into consideration on the estimation of popularity. That is, according to the place popularity estimation system according to one embodiment of the present invention, it is possible to properly estimate popularity of a place such as a facility, in consideration of user's visiting.

### Advantageous Effects of Invention

According to one embodiment of the present invention, since posted data is appropriately taken into consideration on estimation of popularity, it is possible to properly estimate popularity of a place such as a facility, in consideration of user's visiting.

### BRIEF DESCRIPTION OF DRAWINGS

FIG. 1 is a diagram showing a configuration of a server, which is a place popularity estimation system according to an embodiment of the present invention.

FIG. 2 is a view showing a microblog management table.

FIG. 3 is a view showing a facility information management table.

FIG. 4 is a view showing a visiting rule morpheme management table.

FIG. 5 is a view showing a facility and microblog association management table.

FIG. 6 is a view showing a mesh statistical population management table.

FIG. 7 is a view showing a facility score management table.

FIG. 8 is a flowchart showing entire processing executed by a server, which is a place popularity estimation system according to an embodiment of the present invention.

FIG. 9 is a flowchart showing determination and counting processing among processing executed by a server, which is a place popularity estimation system according to an embodiment of the present invention.

FIG. 10 is a diagram showing a hardware configuration of a server, which is a place popularity estimation system according to an embodiment of the present invention.

### DESCRIPTION OF EMBODIMENTS

Hereinafter, an embodiment of a place popularity estimation system according to the present invention will be described in detail with reference to the drawings. Note that, in the description of the drawings, the same elements are denoted by the same reference numerals, and redundant descriptions are omitted.

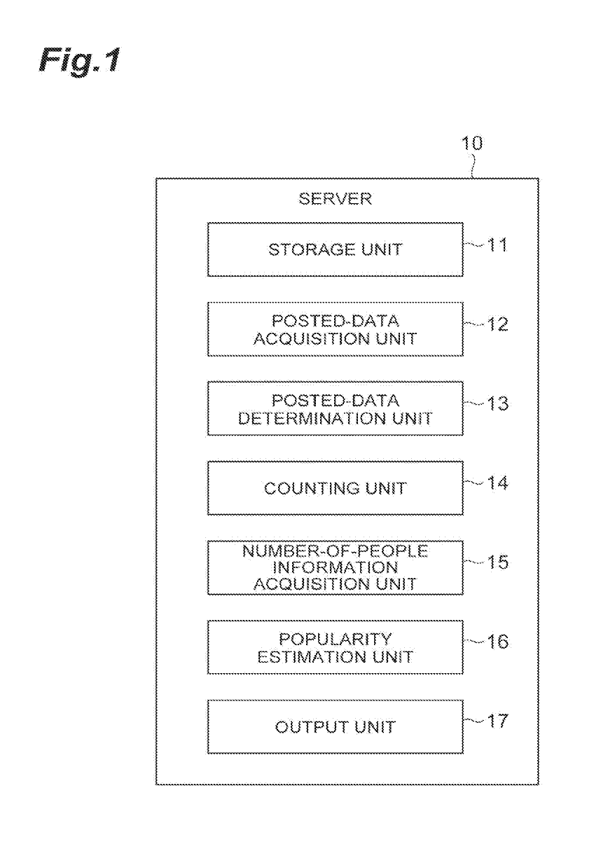

FIG. 1 shows a server 10, which is a place popularity estimation system according to the present embodiment. The server 10 is a system (device) configured to estimate popularity of a place. In the present embodiment, places to be a popularity estimation target are facilities such as a shop, a leisure facility, and a tourist facility. Meanwhile, a place to be the popularity estimation target may be any place whose location can be specified, and may be a place other than a facility, for example, a sightseeing spot other than a facility, a point of interest (POI), and the like. The popularity indicates how popular as a facility visited by users, that is, how many users are visiting the facility. The estimated popularity can be used, for example, to provide facility information to users. Specifically, based on a rank of popularity of facilities, it is possible to display a facility with high popularity at a higher position when info illation of a facility searched by a user, or recommend a facility with high popularity to neighboring users.

The server 10 is connected to a network such as the Internet, and can communicate with other devices. The server 10 transmits and receives information to be used for estimating popularity of a facility with other devices. What kind of information is exchanged with what kind of device will be described later.

Next, functions of the server 10 according to the present embodiment will be described. As shown in FIG. 1, the server 10 is configured to include a storage unit 11, a posted-data acquisition unit 12, a posted-data determination unit 13, a counting unit 14, a number-of-people information acquisition unit 15, a popularity estimation unit 16, and an output unit 17.

The storage unit 11 is a functional unit configured to store information necessary for processing in the server 10. What kind of information the storage unit 11 stores will be described later.

The posted-data acquisition unit 12 is a functional unit configured to acquire posted data that has been posted from a user. The posted data acquired by the posted-data acquisition unit 12 is, for example, data including a text that has been posted (sent) to a microblog from a user terminal, which is a mobile communication terminal of an unspecified number of users. The posted data may include location information indicating a location where the text is posted, that is, a geotag. The location information is, for example, information indicating a location of the user terminal when the text is posted. The location information is, for example, information indicating a latitude and longitude of a location of the user terminal acquired by the GPS function in the user terminal. Note that a service of microblog is provided by a microblog server.

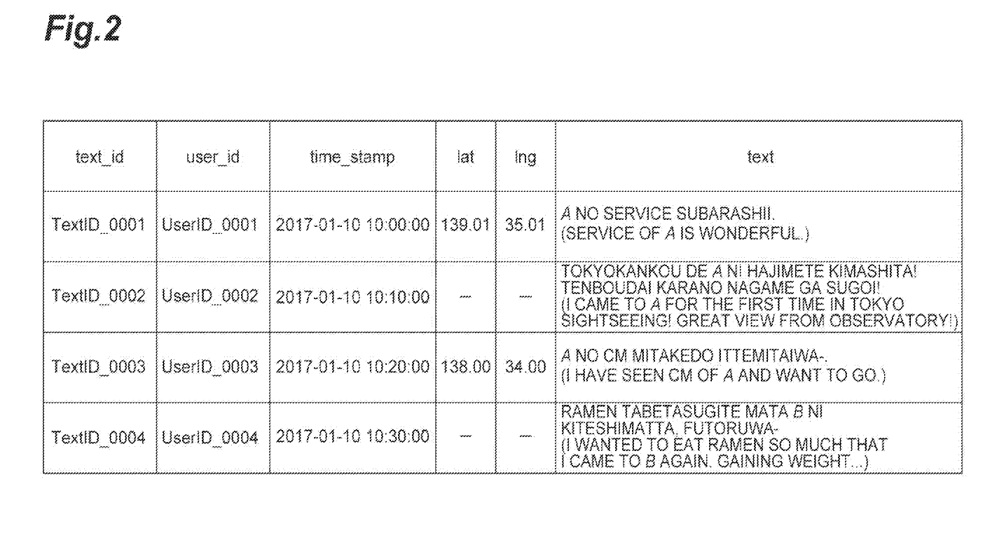

The storage unit 11 stores posted data. The storage unit 11 holds posted data in a microblog management table. FIG. 2 shows the microblog management table. One row (record) is information on one posted data. As shown in FIG. 2, the microblog management table stores information associated individually in columns of text_id, user_id, time_stamp, lat, lng, and text. The information stored in the text_id column is an identifier for identifying a posted text (posted data). The information stored in the user_id column is an identifier for identifying a user who has posted the text. The identifier is, for example, an identifier used for identifying a user in the microblog. The information stored in the time_stamp column is information indicating a time when the text has been posted, specifically, the year, month, date, time, minute, and second when the text has been posted.

The pieces of information stored in the lat and lng columns are location information indicating a location where the text has been posted, specifically, information indicating latitude and longitude, respectively. Location information may not be included in posted data depending on settings and the like at a time of posting. For example, the posted data in the second and fourth rows of the microblog management table shown in FIG. 2 does not include location information. The information stored in the text column is a posted text (character string). In the present embodiment, an example of a case where the posted text is Japanese is shown, but a position embodiment of the present invention can be implemented similarly as in the present embodiment even if it is other than Japanese.

Posted data stored in the microblog management table is acquired from the microblog server in advance by the server 10. Alternatively, this information may be acquired from the microblog server and inputted to the server 10 in advance, by an administrator or the like of the server 10.

The posted-data acquisition unit 12 reads and acquires a plurality of posted data stored in the microblog management table. The posted-data acquisition unit 12 may acquire only posted data in which the time when the text is posted is in a time zone preset in advance, for example, a time zone corresponding to number-of-people information described later. Further, the posted-data acquisition unit 12 may request posted data from the microblog server and receive the posted data from the microblog server. The posted-data acquisition unit 12 outputs the acquired posted data to the posted-data determination unit 13.

The posted-data determination unit 13 is a functional unit configured to determine whether the posted data acquired by the posted-data acquisition unit 12 relates to a facility to be estimated and also indicates that a user who has posted the posted data has visited the facility to be estimated. The posted data relating to the facility to be estimated means that the text of the posted data describes about the facility, for example. The posted-data determination unit 13 may determine whether or not the text included in the posted data includes a description corresponding to the facility to be estimated, to determine whether or not the posted data relates to the facility to be estimated.

The posted-data determination unit 13 may determine whether the posted data indicates that a user who has posted the posted data has visited the facility to be estimated, based on the text included in the posted data. Alternatively, the posted-data determination unit 13 may determine whether the posted data indicates that a user who has posted the posted data has visited the facility to be estimated, based on location information included in the posted data.

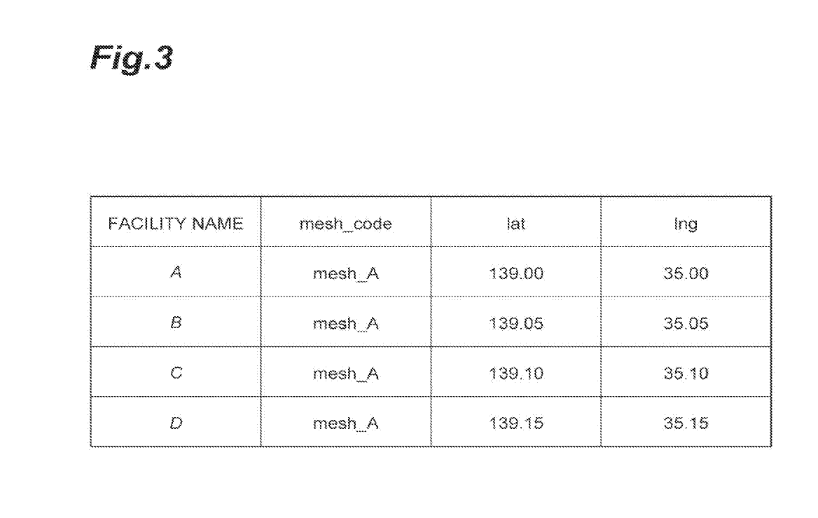

The storage unit 11 stores information to be used for the determination. The storage unit 11 holds the information in a facility information management table and a visiting rule morpheme management table. FIG. 3 shows the facility information management table. The facility information management table is a table that holds information on a facility to be estimated. One row (record) is information on one facility.

As shown in FIG. 3, the facility information management table stores information associated individually in columns of facility name, mesh_code, lat, and lng. The information stored in the facility name column is a character string that is a facility name of the facility. The information stored in the mesh_code column is an identifier for identifying a mesh including a location of the facility. Mesh is a division of an area where facilities are provided. Each mesh is, for example, a rectangle with one side of several tens of meters to several hundreds of meters. For example, the information on the four facilities in the facility information management table shown in FIG. 3 is all located in a same mesh. The pieces of information stored in the lat and lng columns are location information indicating a location of the facility, specifically, information indicating latitude and longitude, respectively.

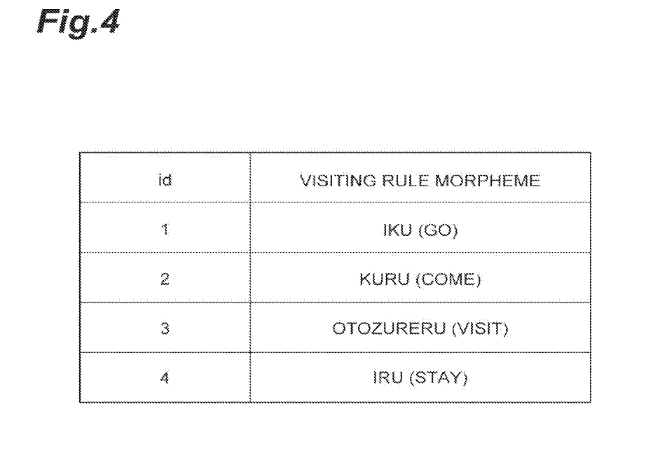

FIG. 4 shows the visiting rule morpheme management table. The visiting rule morpheme management table is a table that holds information to be used for determining whether posted data indicates that a user who has posted the posted data has visited a facility to be estimated. As shown in FIG. 4, the visiting rule morpheme management table stores information associated individually in columns of id and visiting rule morpheme. The information stored in the id column is an identifier for identifying individual information stored in the visiting rule morpheme management table. The information stored in the visiting rule morpheme column is a character string that is a morpheme to be used for the above determination. The character string indicates visiting to a facility by a user, such as “iku (go)”, “kuru (come)”, “otozureru (visit)”, “iru (stay)”, or the like as shown in FIG. 4, for example. The information held in the facility information management table and the visiting rule morpheme management table is previously inputted to the server 10, by an administrator or the like of the server 10.

The posted-data determination unit 13 performs determination as follows. The posted-data determination unit 13 inputs posted data from the posted-data acquisition unit 12. Further, the posted-data determination unit 13 reads the information held in the facility information management table and the visiting rule morpheme management table. The posted-data determination unit 13 performs determination for each inputted posted data. The posted-data determination unit 13 performs morphological analysis on a text included in the posted data. The morphological analysis is performed using any conventional method. In the morphological analysis, the tense of each morpheme may be set to be present.

The posted-data determination unit 13 determines, for each morpheme obtained by morphological analysis, whether there is a morpheme coincident with a facility name. The determination of coincidence is made for facility names of all facilities. When determining that any morpheme coincides with a facility name, the posted-data determination unit 13 determines that the posted data relates to a facility having this facility name. That is, when a facility name is included in the text, it is determined that the posted data relates to a facility having this facility name. When determining that no morpheme coincides with a facility name, the posted-data determination unit 13 determines that the posted data does not relate to any facility.

When determining that the posted data relates to any facility, the posted-data determination unit 13 subsequently determines whether the posted data includes (is provided with) location information. When determining that the posted data includes location information, the posted-data determination unit 13 determines whether or not a location indicated by the location information is within the mesh of the facility regarded to be related to the posted data. The posted-data determination unit 13 stores a correspondence between the latitude and longitude and the mesh in advance, and performs the above determination based on the correspondence.

When determining that a location indicated by the location information included in the posted data is within the mesh of the facility, the posted-data determination unit 13 determines that the posted data indicates that a user who has posted the posted data has visited the facility. That is, in this case, the posted-data determination unit 13 determines (classifies) that there is a visit flag for the posted data. This determination is based on that there is probability that the user has visited the facility in a case where posting related to the facility has been performed and a location where the posting has been performed is within the mesh of the facility. When determining that a location indicated by the location information included in the posted data is not within the mesh of the facility, the posted-data determination unit 13 does not determine that the posted data indicates that a user who has posted the posted data has visited the facility. That is, in this case, the posted-data determination unit 13 determines (classifies) that there is no visit flag for the posted data.

Meanwhile, the above determination is for determining whether or not a location related to the posted data is within the mesh of the facility, but for example, the determination may be made based on a distance between the location related to the posted data and a location of the facility as described below. The posted-data determination unit 13 calculates a distance between the latitude and longitude indicating a location related to the posted data and the latitude and longitude indicating a location of the facility included in the facility information management table. The posted-data determination unit 13 compares the calculated distance with a preset threshold value (e.g., several meters to several tens of meters). When determining that the distance is equal to or less than the threshold value through the comparison, the posted-data determination unit 13 determines (classifies) that there is a visit flag for the posted data. When determining that the distance is not equal to and not less than the threshold value through the comparison, the posted-data determination unit 13 determines (classifies) that there is no visit flag for the posted data.

When determining that the posted data does not include location information, the posted-data determination unit 13 determines, for each morpheme obtained through the morphological analysis, whether there is a morpheme coincident with a visiting rule morpheme. This determination of coincidence is made for all visiting rule morphemes. When determining that any morpheme coincides with a visiting rule morpheme, the posted-data determination unit 13 determines that the posted data indicates that a user who has posted the posted data has visited the facility. That is, in this case, the posted-data determination unit 13 determines (classifies) that there is a visit flag for the posted data. This determination is based on that there is probability that the user has visited the facility in a case where posting related to the facility has been performed and a character string indicating visiting to the facility is included in the posted text. When determining that no morpheme coincides with a visiting rule morpheme, the posted-data determination unit 13 does not determine that the posted data indicates that a user who has posted the posted data has visited the facility. That is, in this case, the posted-data determination unit 13 determines (classifies) that there is no visit flag for the posted data.

There will be shown an example of the above determination on posted data shown in FIG. 2. A text related to the posted data having text_id of “textID-0001” (posted data in the first row of the microblog management table in FIG. 2) becomes “A/no/service/subarashii” through the morphological analysis (“/” indicates a break between morphemes). Among these morphemes, there is a morpheme “A”, which is a facility name. Since the posted data includes location information, it is determined whether or not a location indicated by the location information (139.01, 35.01) is within a mesh “mesh_A” of a facility having the facility name “Λ”. Since the location is within the mesh, it is determined that the posted data relates to the facility having the facility name “A” and there is a visit flag.

A text related to the posted data having text_id of “textID-0002” (posted data in the second row of the microblog management table in FIG. 2) becomes “Tokyo/kankou/de/A/ni/hajimete/kuru/!/Tenboudai/kara/no/nagame/ga/sugoi/!” through the morphological analysis. Among these morphemes, there is a morpheme “A”, which is a facility name. Since the posted data does not include location information, it is determined whether or not there is a morpheme coincident with a visiting rule morpheme in the morphemes. Among these morphemes, there is a morpheme “kuru (come)”, which is a visiting rule morpheme. Therefore, it is determined that the posted data relates to the facility having the facility name “A” and there is a visit flag.

A text related to the posted data having text_id of “textID-0003” (posted data in the third row of the microblog management table in FIG. 2) becomes “A/no/CM/mini/kedo/iku/mitai/wa-” through the morphological analysis. Among these morphemes, there is a morpheme “A”, which is a facility name. Since the posted data includes location information, it is determined whether or not a location indicated by the location information (138.00, 34.00) is within the mesh “mesh A” of the facility having the facility name “A”. Since the location is not within the mesh, it is determined that the posted data relates to the facility having the facility name “A” and there is no visit flag.

The posted data having text_id of “textID-0004” (posted data in the fourth row of the microblog management table in. FIG. 2) is determined to be related to a facility having a facility name “B” and have a visit flag, through determination similar to the one above.

The posted-data determination unit 13 outputs information indicating the above determination result to the counting unit 14 for each posted data. For example, for the posted data regarded to be related to any facility, the posted-data determination unit 13 outputs, to the counting unit 14, information indicating the facility and information indicating whether or not it is determined that the posted data indicates that a user who has posted the posted data has visited a facility to be estimated.

The counting unit 14 is a functional unit configured to count posted data for a facility to be estimated, in accordance with the determination by the posted-data determination unit 13. The counting unit 14 inputs information indicating the determination result from the posted-data determination unit 13. Based on the information, for each facility, the counting unit 14 counts the number of posted data determined to indicate that the user has visited the facility, and the number of posted data not determined to indicate that the user has visited the facility, among the posted data determined to be related to the facility.

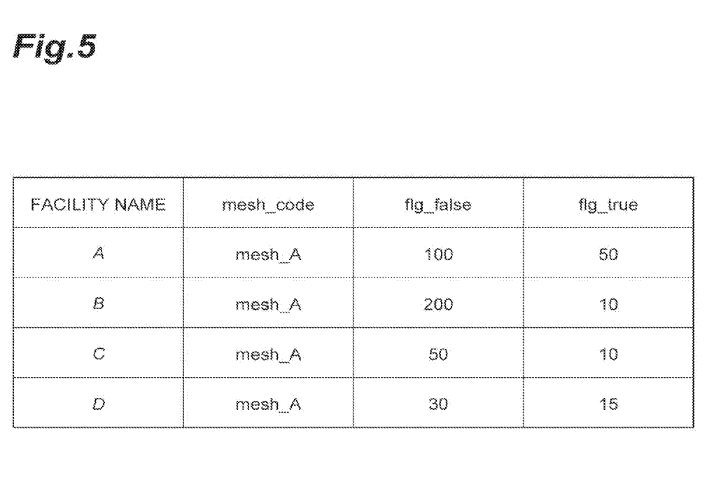

The number counted by the counting unit 14 is collected in, for example, a facility and microblog association management table shown in FIG. 5. As shown in FIG. 5, the facility and microblog association management table stores information associated individually in columns of facility name, mesh_code, flg_false, and flg_true. The pieces of information stored in the facility name and mesh_code columns respectively are a character string that is a facility name of a facility related to the number to be counted, and an identifier of a mesh including a location of the facility. The information stored in the flg_false column is the number of posted data determined to have no visit flag, among the posted data determined to be related to the facility. The information stored in the flg_true column is the number of posted data determined to have a visit flag, among the posted data determined to be related to the facility. The number of flg_true is the (estimated) number that a user has posted about the facility after visiting the facility. The counting unit 14 outputs, to the popularity estimation unit 16, information of the facility and microblog association management table shown in FIG. 5 obtained by the counting.

Meanwhile, the above number may be the number of users rather than the number of posted data (the number of posts). That is, even if a same user makes multiple postings on which same determination is made, it is counted as 1 rather than being counted for plurality of times. With this counting, even if one user makes postings many times on which same determination is made, popularity of the facility can be estimated without considering the number of postings per user.

The number-of-people information acquisition unit 15 is a functional unit configured to acquire number-of-people information indicating the number of people who are located in an area including a facility to be estimated. For example, this area is the above-described mesh, and the number-of-people information is information indicating the number of people per mesh and per time zone.

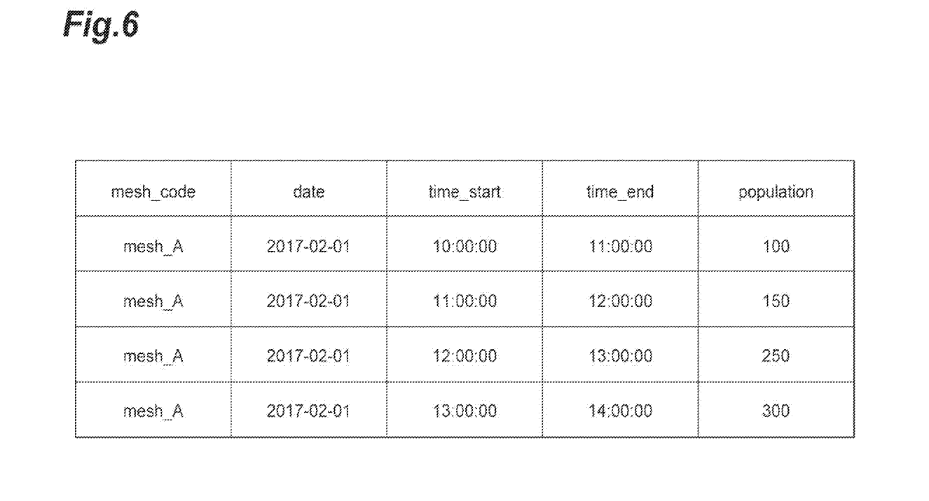

The storage unit 11 stores number-of-people information. The storage unit 11 holds the number-of-people information in a mesh statistical population management table. FIG. 6 shows the mesh statistical population management table. One row (record) is the number-of-people information for one mesh and one time zone. As shown in FIG. 6, the mesh statistical population management table stores information associated individually in columns of mesh_code, date, time_start, time_end, and population. The information stored in the mesh_code column is an identifier of a mesh related to number-of-people information. The pieces of information stored in the date, time_start, and time_end columns are information indicating a time zone related to number-of-people information. The information stored in the date column is information indicating year, month, and date. The pieces of information stored in the time_start and time_end columns are information indicating time, minute, and second of a start time and of an end time respectively, of a corresponding time zone. The information stored in the population column is the number of people in a mesh and a time zone.

The number of people in each mesh can be obtained based on information indicating a location of a mobile communication terminal (user terminal) such as a cellular phone, for example. By counting the number of mobile communication terminals for each mesh, the number-of-people information of the mesh is obtained. The data stored in the mesh statistical population management table is acquired by the server 10 in advance from, for example, a server and the like of a communication carrier of mobile communication that provides the number-of-people information. Alternatively, this information may be acquired from a server and the like of this communication carrier and inputted to the server 10 in advance, by an administrator or the like of the server 10.

The number-of-people information acquisition unit 15 reads and acquires the number-of-people information stored in the mesh statistical population management table. The number-of-people information acquisition unit 15 may acquire only number-of-people information of a preset time zone (e.g., previous one hour, one day, one week, one month, and the like from the present time). In addition, the number-of-people information acquisition unit 15 may request number-of-people information from a server or the like of a communication carrier, to receive and acquire the number-of-people information from the server or the like of the communication carrier. The number-of-people information acquisition unit 15 outputs the acquired number-of-people information to the popularity estimation unit 16.

The popularity estimation unit 16 is a functional unit configured to estimate popularity of a facility to be estimated, based on a value counted by the counting unit 14 and the number of people indicated by number-of-people information acquired by the number-of-people information acquisition unit 15. The popularity estimation unit 16 may perform weighting corresponding to the value counted by the counting unit 14 for the number of people indicated by the number-of-people information acquired by the number-of-people information acquisition unit 15, to calculate a score indicating popularity of the facility to be estimated. The popularity estimation unit 16 may estimate popularity of the facility to be estimated, based on a ratio of a value counted by the counting unit 14 for each facility in the mesh that is an area including the facility to be estimated.

The popularity estimation unit 16 inputs information individually from the counting unit 14 and the number-of-people information acquisition unit 15. Based on the inputted information, the popularity estimation unit 16 calculates a score indicating popularity of each facility, and the popularity estimation unit 16 estimates the popularity. The popularity estimation unit 16 calculates a score POP (POI) indicating popularity of the facility POI by the following formula.

$$POP ( POI ) = \frac{P}{α + β} \{ ( α \frac{flg\_false ( POI )}{sum ( flg\_false )} ) + ( β \frac{flg\_true ( POI )}{sum ( flg\_true )} ) \} \qquad [ Formula 1 ]$$

In the above formula, P is the number of people in the mesh including a facility to be estimated. The popularity estimation unit 16 calculates P from the number of people indicated by number-of-people information. For example, the popularity estimation unit 16 sets P for an average value of number-of-people information in one hour unit of the mesh, by using the number-of-people information for one day. flg_false (POI) and flg_true (POI) are values of flg_false and flg_true of the facility, respectively. sum (flg_false) is a sum of values of flg_false of all facilities included in the mesh. sum (flg_true) is a sum of values of flg_true of all facilities included in the mesh. α and β are weight coefficients of respective preset terms. For example, α=β=1. Meanwhile, when it is desired that a weight of posted data regarded to have a visit flag is made higher than a weight of posted data regarded to have no visit flag, the value of β may simply be made larger than the value of α. Further, α and β may be appropriately adjusted by tuning.

As shown in the above formula, the score POP (POI) is obtained by weighting the number of people in the mesh with the respective values of flg_false (POI) and flg_true (POI). The score POP (POI) is an index value of the number of people who have visited the facility. As the score POP (POI) is larger, more people are considered to have visited, indicating that the facility has high popularity.

For example, assume that facilities located in the mesh are the four facilities shown in the facility and microblog association management table of FIG. 5, and the values of flg_false and flg_true for the individual facilities are those shown in the table. Further, assume that the average value P of the number of people in the mesh is 200. In this case, the score POP (POI) for each facility is as follows.

POP(A)=200/2*{(1*100/380)+(1*50/85)}=100*(0.263+0.588)=85.1

POP(B)=200/2*{(1*200/380)+(1*10/85)}=100*(0.526+0.118)=64.4

POP(C)=200/2*{(1*50/380)+(1*10/85)}=100*(0.132+0.118)=25.0

POP(D)=200/2*{(1*30/380)+(1*15/85)}=100*(0.079+0.176)=25.5

Meanwhile, number-of-people information for one day is used in the above example, but only number-of-people information in a specific time zone may be used. For example, number-of-people information in a midnight time zone in which the facility (shop) is not operating may not be used. Further, an average value of the number of people per time zone during a day may be calculated from number-of-people information of a plurality of days (e.g., one month), to calculate the score of the facility for each time zone. That is, popularity of the facility for each time zone may be estimated.

Further, the values of fig_false and flg_true for each facility may be calculated by using only posted data corresponding to the time zone of number-of-people information to be used for calculating the average of the number of people.

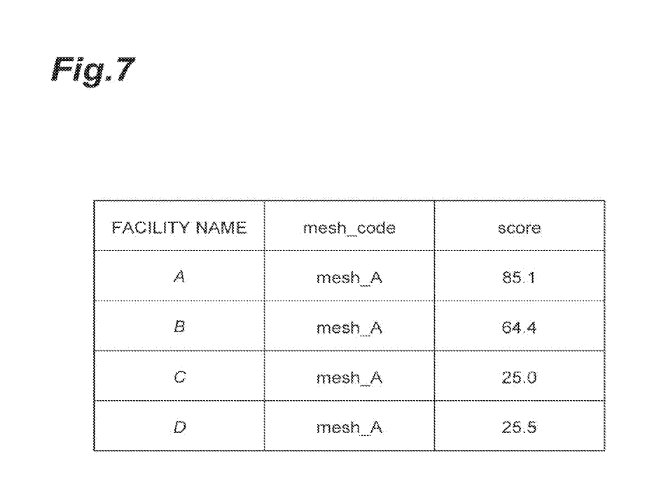

The popularity estimation unit 16 collects the calculated scores, for example, in a facility score management table shown in FIG. 7. As shown in FIG. 7, the facility score management table stores information associated individually in columns of facility name, mesh_code, and score. The pieces of information stored in the facility name and mesh_code columns respectively are a character string that is a facility name of a facility related to a calculated score, and an identifier of a mesh including a location of the facility. The information stored in the score column is a calculated score. The popularity estimation unit 16 outputs information of the facility score management table to the output unit 17.

The output unit 17 is a functional unit configured to output information indicating popularity estimated by the popularity estimation unit 16. The output unit 17 inputs information of the facility score management table shown in FIG. 7 from the popularity estimation unit 16. For example, the output unit 17 outputs the information of the facility score management table shown in FIG. 7 to the storage unit 11 and causes the storage unit 11 to store. The information of the facility score management table stored in the storage unit 11 is referred to by a device, a module, or the like that provides facility information to a user. Alternatively, the output unit 17 may transmit this information to the device or the module.

Note that the operation of each functional unit above is performed, for example, at a timing when a trigger is inputted to the server 10 by an administrator or the like of the server 10, or at a preset timing. Specifically, it is performed before or at a time of providing facility information to a user. The above is the function of the server 10 according to the present embodiment.

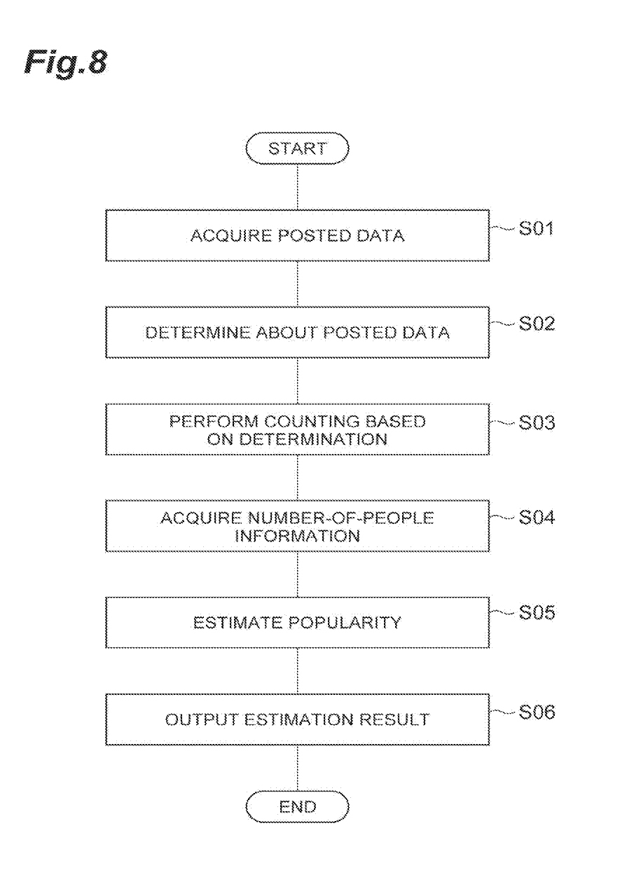

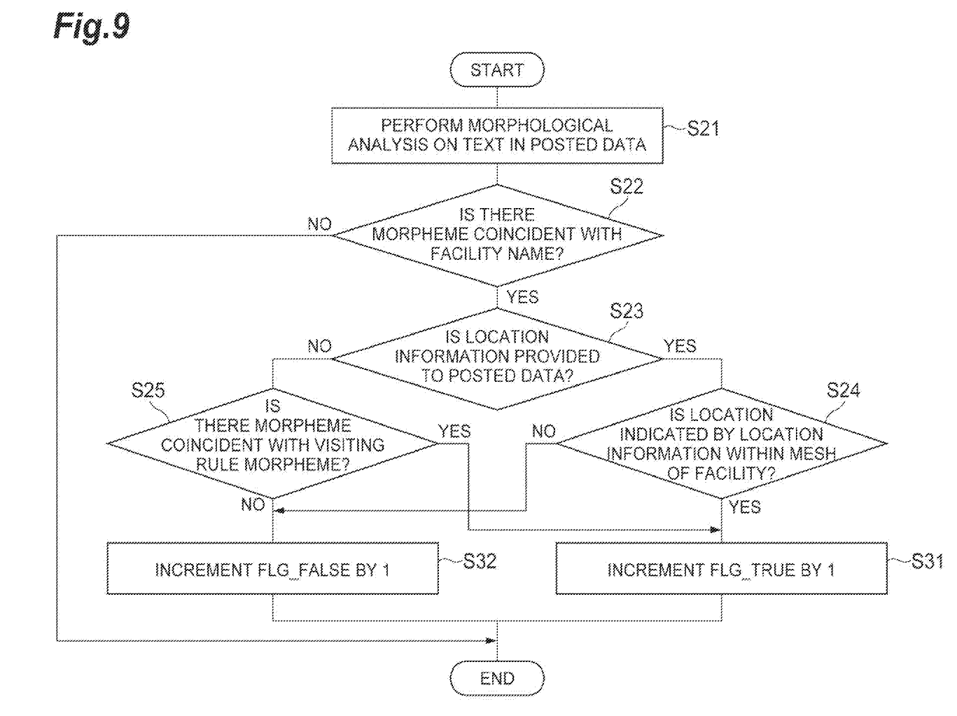

Next, processing executed by the server 10 according to the present embodiment (operation method performed by the server 10) will be described with reference to flowcharts of FIGS. 8 and 9. With reference to the flowchart of FIG. 8, processing of the entire process will be described.

In this processing, first, the posted-data acquisition unit 12 acquires posted data (S01). Subsequently, the posted-data determination unit 13 determines whether each posted data relates to a facility to be estimated, and determines the presence or absence of a visit flag (S03). Subsequently, the counting unit 14 performs counting in accordance with the determination by the posted-data determination unit 13 (S03).

Processing of the above determination (S02) and counting (S03) will be described in detail with reference to the flowchart of FIG. 9. This processing is performed for each posted data for all posted data. In this processing, first, the posted-data acquisition unit 12 performs morphological analysis on a text included in the posted data (S21). Subsequently, the posted-data determination unit 13 determines, for each morpheme, whether there is a morpheme coincident with a facility name (S22). When the posted-data determination unit 13 determines that no morpheme coincides with a facility name (NO in S22), it is determined that the posted data does not relate to any facility. In this case, the posted data is not to be counted, and the processing on the posted data is terminated.

When the posted-data determination unit 13 determines that any morpheme coincides with a facility name (YES in S22), it is determined that the posted data relates to a facility having this facility name. Subsequently, the posted-data determination unit 13 determines whether the posted data includes (is provided with) location information (S23). When the posted-data determination unit 13 determines that the posted data includes location information (YES in S23), subsequently, it is determined whether or not a location indicated by the location information is within a mesh of the facility regarded to be related to the posted data (S24).

When the posted-data determination unit 13 determines that the location indicated by the location information included in the posted data is within the mesh of the facility (YES in S24), the posted data is determined (classified) to have a visit flag. Subsequently, in accordance with the determination, the counting unit 14 increments the value of flg_true for the facility by 1 (S31). Whereas, in S24, when the posted-data determination unit 13 determines that the location indicated by the location information included in the posted data is not within the mesh of the facility (NO in S24), the posted data is determined (classified) to have no visit flag (S32). Subsequently, in accordance with the determination, the counting unit 14 increments the value of flg_false for the facility by 1. The values of flg_true and flg_false for each facility are set to 0 before the processing of determination (S02) and counting (S03).

In S23, when the posted-data determination unit 13 deter mines that the posted data does not include location information (NO in S23), subsequently, it is determined, for each morpheme, whether there is a morpheme coincident with a visiting rule morpheme (S25). When the posted-data determination unit 13 determines that any morpheme coincides with a visiting rule morpheme (YES in S25), the posted data is determined (classified) to have a visit flag. Subsequently, in accordance with the determination, the counting unit 14 increments the value of flg_true for the facility by 1 (S31). Whereas, in S25, when the posted-data determination unit 13 determines that no morpheme coincides with a visiting rule morpheme (NO in S25), the posted data is determined (classified) to have no visit flag. Subsequently, in accordance with the determination, the counting unit 14 increments the value of flg_false for the facility by 1 (S32). The above is the processing of determination (S02) and counting (S03).

Returning to FIG. 8, subsequently, the number-of-people information acquisition unit 15 acquires number-of-people information (S04). Subsequently, based on a value counted by the counting unit 14 and the number-of-people information acquired by the number-of-people information acquisition unit 15, the popularity estimation unit 16 calculates a score indicating popularity of the facility (S05). Subsequently, the output unit 17 outputs information indicating the estimated popularity (S06). The above is the processing executed by the server 10 according to the present embodiment.

In the present embodiment, determination is made as to whether posted data relates to a facility to be estimated and indicates that a user who has posted the posted data has visited the facility to be estimated. Posted data is counted in accordance with the determination, and popularity of the facility to be estimated is estimated based on the counted value and the number-of-people information. Therefore, the posted data is appropriately taken into consideration on the estimation of popularity. Therefore, according to the place popularity estimation system according to one embodiment of the present invention, it is possible to properly estimate popularity of a place such as a facility, in consideration of user's visiting.

Consider, for example, a case where the counted values are those shown in the facility and microblog association management table of FIG. 5. In the numbers of posted data related to the facilities to be estimated, that is, sums of the values of flg_false and flg_true, 200+10 of the facility having the facility name “B” is largest. Therefore, in a case where determination is not made as to whether the posted data indicates that the user has visited the facility, the facility having the facility name “B” is estimated to be the most popular.

Whereas, the facility having the facility name “A” has the largest number of the posted data indicating that the user has visited the facility, and the facility considered to have been visited by the largest number of users is the facility having the facility name “A”. For the facility having the facility name “B”, the number of the posted data indicating that the user has visited the facility is relatively small. Therefore, in a case of considering user's visiting, it is considered appropriate to estimate that the facility having the facility name “A” is most popular. In the present embodiment, as shown in the facility score management table of FIG. 7, the facility having the facility name “A” is regarded to be the most popular, and appropriate estimation is made.

Further, if the number of posted data related to the facility to be estimated is used, popularity of the facility with the facility name “C” is higher than popularity of the facility with the facility name “D”. However, similarly to the case of “A” and “B” above, in the present embodiment, the popularity of the facility of “D” is higher than the popularity of the facility of “C”.

Further, since posted data not indicating that the user has visited the facility, that is, flg_false is also counted and used for estimating popularity, it is possible to perform appropriate estimation taking into consideration of a reputation and the like of the facility, rather than estimation based only on user's visiting. The estimated popularity is used for providing information to a user as described above. Therefore, by appropriately estimating popularity, only appropriate information can be used as the information provided to a user, and it is possible to reduce an amount of communication between with a terminal and to reduce a processing load when providing the information. That is, according to the present embodiment, it is possible to efficiently utilize network resources or hardware resources at a time of providing information.

Further, as in the present embodiment, a text and location information included in the posted data may be used to determine whether the posted data relates to the facility to be estimated, and to determine whether the posted data indicates that the user has visited the facility to be estimated. According to this configuration, it is possible to perform an appropriate and reliable determination and to appropriately and reliably implement one embodiment of the present invention. However, the above determination is not necessarily performed by the above-described method using the above-mentioned info illation, and may be performed by any method using the posted data.

Further, as in the present embodiment, a score may be calculated by performing weighting corresponding to values of flg_false and flg_true for the number of people in a mesh indicated by number-of-people information. According to this configuration, it is possible to appropriately and reliably estimate popularity of a facility.

Furthermore, as in the formula for calculating a score of the present embodiment, a score of popularity may be calculated by using ratio values of flg_false and flg_true to a sum of the values of flg_false and flg_true of all the facilities included in the mesh. Typically, the number of posted data with a visit flag is fewer than that of posted data without a visit flag. By using the ratio values as described above, it is possible to appropriately and easily increase the weight of the posted data having a visit flag. Therefore, according to this configuration, it is possible to more appropriately estimate popularity of a facility. However, it is not always necessary to use the ratio values above and the above-described formula for calculating a score, and estimation may be performed as long as it is estimation of popularity based on a counted value.

Meanwhile, in the determination in the present embodiment, the facility name is used as the description corresponding to a facility n the text as described above, but a character string other than that may be used as long as it is a character string corresponding to the facility.

Note that the block diagram used in the description of the above embodiment shows blocks in units of function. These functional blocks (constituent parts) are realized by any combination of hardware and/or software. Further, realizing means for each functional block is not particularly limited. That is, each functional block may be realized by one device physically and/or logically bound, or may be realized by a plurality of devices by directly and/or indirectly (e.g., wired and/or wireless) connecting two or more devices that are physically and/or logically separated.

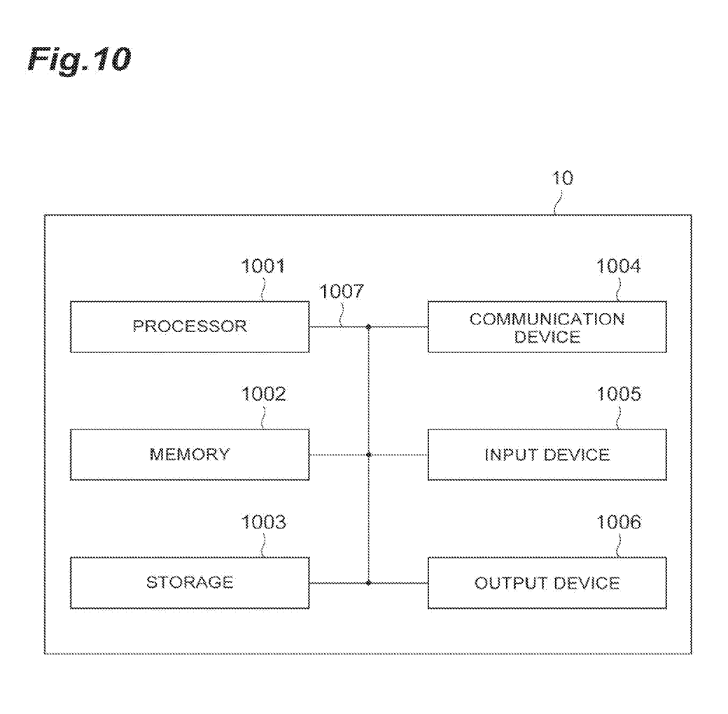

For example, the server 10 according to one embodiment of the present invention may function as a computer configured to perform processing of the server 10 of the present embodiment. FIG. 10 is a diagram showing an example of a hardware configuration of the server 10 according to the present embodiment. The above-described server 10 may be physically configured as a computer device including a processor 1001, a memory 1002, a storage 1003, a communication device 1004, an input device 1005, an output device 1006, a bus 1007, and the like.

Note that, in the following description, the term “device” can be read as a circuit, device, unit, or the like. The hardware configuration of the server 10 may be configured so as to include one or a plurality of the individual devices shown in the figure or may be configured excluding some devices.

Each function of the server 10 is realized by causing predetermined software (program) to be loaded on hardware such as the processor 1001 and the memory 1002, to allow the processor 1001 to perform calculation and control of communication by the communication device 1004, and reading and/or writing of data in the memory 1002 and the storage 1003.

The processor 1001, for example, operates an operating system to control the entire computer. The processor 1001 may be configured with a central processing unit (CPU) including an interface with a peripheral device, a control device, an arithmetic device, a register, and the like. For example, each of the functional units 11 to 17 of the server 10 may be realized including the processor 1001.

Further, the processor 1001 reads a program (program code), a software module, and data from the storage 1003 and/or the communication device 1004 to the memory 1002, and executes various types of processing in accordance with these. As the program, there is used a program for causing a computer to execute at least part of the operation described in the above embodiment. For example, the functional units 11 to 17 of the server 10 may be realized by a control program stored in the memory 1002 and operating with the processor 1001, and other functional blocks may be similarly realized. It has been described that the above-described various types of processing are executed by one processor 1001, but may be executed simultaneously or sequentially by two or more processors 1001. The processor 1001 may be implemented with one or more chips. Meanwhile, the program may be transmitted from the network via an electric communication line.

The memory 1002 is a computer-readable recording medium and is configured with, for example, at least one of a read only memory (ROM), an erasable programmable ROM (EPROM), an electrically erasable programmable ROM (EEPROM), a random access memory (RAM), or the like. The memory 1002 may also be referred to as a register, a cache, a main memory (main storage device), or the like. The memory 1002 can store an executable program (program code), a software module, and the like for implementing the method according to one embodiment of the present invention.

The storage 1003 is a computer-readable recording medium, and may be configured with, for example, at least one of an optical disk such as a compact disc ROM (CD-ROM), a hard disk drive, a flexible disk, a. magneto-optical disk (e.g., a compact disk, a digital versatile disk, a Blu-ray (registered trademark) disk), a smart card, a flash memory (e.g., a card, a stick, a key drive), a floppy (registered trademark) disk, a magnetic strip, or the like. The storage 1003 may also be referred to as an auxiliary storage device. The above-described storage medium may be, for example, a database, a server, or other appropriate medium including the memory 1002 and/or the storage 1003.

The communication device 1004 is hardware (transmission/reception device) to perform communication between computers via a wired and/or wireless network, and also referred to as, for example, a network device, a network controller, a network card, a communication module, or the like. For example, each of the functional units 11 to 17 of the server 10 described above may be realized including the communication device 1004.

The input device 1005 is an input device (e.g., a keyboard, a mouse, a microphone, a switch, a button, a sensor, or the like) configured to accept an input from the outside. The output device 1006 is an output device (e.g., a display, a speaker, an LED lamp, or the like) configured to perform output to the outside. Meanwhile, the input device 1005 and the output device 1006 may also have an integrated configuration (e.g., a touch panel).

In addition, the individual devices such as the processor 1001 and the memory 1002 are connected by the bus 1007 that is for communication of information. The bus 1007 may be configured with a single bus or may be configured with buses different between the devices.

Further, the server 10 may include hardware such as a microprocessor, a digital signal processor (DSP), an application specific integrated circuit (ASIC), a programmable logic device (PLD), and a field programmable gate array (FPGA), and part or all of the functional blocks may be realized by the hardware. For example, the processor 1001 may be implemented with at least one of the hardware.

Although the present embodiment has been described in detail above, it will be obvious to those skilled in the art that the present embodiment is not limited to the embodiment described herein. The present embodiment can be implemented as modified and alternated embodiments without departing from the spirit and scope of the present invention as defined by description of the claims. Therefore, the description herein is for the purpose of illustration and does not have any restrictive meaning to the present embodiment.

As long as there is no inconsistency, the order of the processing procedure, the sequence, the flowchart, and the like in each aspect/embodiment described herein may be exchanged. For example, for the method described herein, elements of the various steps are presented in an exemplary order, and are not limited to the specific order presented.

Inputted and outputted information and the like may be stored in a specific place (e.g., a memory) and may be managed in a management table. Information or the like to be inputted and outputted may be overwritten, updated, or additionally written. Outputted information and the like may be deleted. Inputted information and the like may be transmitted to another device.

Determination may be made by a value represented by 1 bit (0 or 1), by a Boolean value (true or false), or by comparison of numerical values (e.g., comparison with a predetermined value).

Each aspect/embodiment described herein may be used individually or in combination, or may be used by switching in accordance with execution. Further, notification of predetermined information (e.g., notification of “being X”) is not limited to being performed explicitly, but may be performed implicitly (e.g., not notifying the predetermined information).

Irrespective of whether software is called software, firmware, middleware, a microcode, a hardware description language, or other name, it should be interpreted broadly to mean an instruction, an instruction set, a code, a code segment, a program code, a program, a subprogram, a software module, an application, a software application, a software package, a routine, a subroutine, an object, an executable file, an execution thread, a procedure, a function, and the like.

In addition, software, an instruction, and the like may be transmitted and received via a transmission medium. For example, in a case where software is transmitted from a website, a server, or other remote source with use of a wired technology such as a coaxial cable, an optical fiber cable, a twisted pair, and a digital subscriber line (DSL), and/or a wireless technology such as infrared ray, radio, or a microwave, these wired and/or wireless technologies are included within the definition of the transmission medium.

Information, a signal, and the like described herein may be represented using any of a variety of different technologies. For example, data, an instruction, a command, information, a signal, a bit, a symbol, a chip, and the like that may be mentioned throughout the entire description above may be represented by a voltage, a current, an electromagnetic wave, a magnetic field or a magnetic particle, an optical field or a photon, or any combination thereof.

Meanwhile, the terms described herein and/or terms necessary for understanding the present specification may be replaced with terms having the same or similar meanings.

The terms “system” and “network” as used herein are used interchangeably.

In addition, information, parameters, and the like described herein may be represented by absolute values, may be represented by relative values from a predetermined value, or may be represented by other corresponding information.

A name used for the above parameters is not limited in any way. In addition, a formula and the like using these parameters may be different from those explicitly disclosed herein.

The mobile communication terminal may also be referred to as, by a person skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

The term “determining” and “determination” as used herein may include a wide variety of actions. “Determining” and “determination” may include considering and the like, for example, that “determining” or “determination” is made on calculating, computing, processing, deriving, investigating, looking up, (e.g., searching in a table, a database, or another data structure), and ascertaining. Further, “determining” and “determination” may include considering and the like that “determining” or “determination” is made on receiving (e.g., receiving information), transmitting (e.g., transmitting information), input, output, and accessing (e.g., accessing data in memory). Further, “determining” and “determination” may include considering that “determining” or “determination” is made on resolving, selecting, choosing, establishing, comparing, and the like. That is, “determining” and “determination” may include considering that “determining” or “determination” is made on some action.

The statement “based on” as used herein does not mean “based only on” unless explicitly stated otherwise. In other words, the statement “based on” means both “based only on” and “based at least on”.

As long as “include”, “including”, and variations thereof are used in the specification or the claims, these terms are intended to be inclusive similarly to the term “comprising”. Furthermore, the term “or” used in the specification or the claims is intended to be not an exclusive disjunction.

In the specification, unless the device is obviously only one in the context or technically, it is intended to include a plurality of devices. In the whole of the present disclosure, unless it is clearly indicated to be a single one from the context, a plurality of ones is included.

### REFERENCE SIGNS LIST

10 server
11 storage unit
12 posted-data acquisition unit
13 posted-data determination unit
14 counting unit
15 number-of-people information acquisition unit
16 popularity estimation unit
17 output unit
1001 processor
1002 memory
1003 storage
1004 communication device
1005 input device
1006 output device
1007 bus

1. A place popularity estimation system for estimating popularity of a place, the place popularity estimation system comprising circuitry configured to:
acquire posted data posted by a user;
determine whether posted data acquired relates to a place to be estimated and also indicates that a user who has posted the posted data has visited the place to be estimated;
count posted data for the place to be estimated in accordance with determination;
acquire number-of-people information indicating the number of people who are located in an area including the place to be estimated;
estimate popularity of the place to be estimated based on a value counted and the number of people indicated by number-of-people information acquired; and
output information indicating popularity estimated.

2. The place popularity estimation system according to claim 1, wherein the circuitry performs weighting corresponding to a value counted for the number of people indicated by number-of-people information acquired, to calculate a score indicating popularity of the place to be estimated.

3. The place popularity estimation system according to claim 1, wherein
the circuitry acquires posted data including a text; and
the circuitry determines whether or not a text included in the posted data includes a description corresponding to the place to be estimated, to determine whether posted data relates to a place to be estimated.

4. The place popularity estimation system according to claim 1, wherein
the circuitry acquires posted data including a text; and
the circuitry determines whether the posted data indicates that a user who has posted the posted data has visited the place to be estimated, based on a text included in the posted data.

5. The place popularity estimation system according to claim 1, wherein
the circuitry acquires posted data including location information indicating a location; and
the circuitry determines whether the posted data indicates that a user who has posted the posted data has visited the place to be estimated, based on location information included in the posted data.

6. The place popularity estimation system according to claim 1, wherein the circuitry estimates popularity of a place to be estimated based on a ratio of a value counted, for each place in an area including the place to be estimated.

7. The place popularity estimation system according to claim 2, wherein
the circuitry acquires posted data including a text; and
the circuitry determines whether or not a text included in the posted data includes a description corresponding to the place to be estimated, to determine whether posted data relates to a place to be estimated.
